(19) United States
(12) Patent Application Publication
(10) Pub. No.: US 2018/0130115 A1
(43) Pub. Date: May 10, 2018

(54) STEALTH MODE GIFT ADVISING

(71) Applicant: International Business Machines Corporation, Armonk, NY (US)

(72) Inventors: Tsz S. Cheng, Grand Prairie, TX (US); Stephanie De La Fuente, Lewisville, TX (US); Charlet N. Givens, Dallas, TX (US)

(21) Appl. No.: 15/343,609

(22) Filed: Nov. 4, 2016

(51) Int. Cl. G06Q 30/06; G06Q 30/02; G06Q 50/00

(52) U.S. Cl. CPC G06Q 30/0631; G06Q 50/01; G06Q 30/0203

(57) ABSTRACT

A user identifier identifying a second user is received from a first user. A plurality of user selectable product content is presented to the second user via at least one web based resource. The second user is not made aware that product content is presented to the second user in order to determine a gift recommendation. To which of the plurality of the user selectable product content the second user responds is determined. A level of interest of the second user in at least one type of the product is determined based, at least in part, on which of the plurality of the user selectable product content the second user responds. Responsive to determining the level of interest of the second user in at least one type of the product, at least a first recommendation for a gift for the second user is determined and presented to the first user.

### BACKGROUND

The present invention relates to data processing systems, and more specifically, to data processing systems that provide Web services.

A Web service is a service hosted by one or more data processing systems and provided to one or more other devices, known as client devices. The client devices and data processing system(s) communicate with each other via the World Wide Web. In a Web service, Web technology such as HTTP, originally designed for human-to-machine communication, is utilized for machine-to-machine communication, for example to transfer machine readable file formats such as XML and JSON. In practice, a Web service typically provides an object-oriented Web-based interface to a database server, utilized for example by another Web server, or by a mobile application, that provides a user interface on a client device for use by an end user. Another common application offered to the end user may be a mashup, where a Web server consumes several Web services at different machines, and compiles the content into one user interface.

### SUMMARY

A method includes receiving, from a first user, a user identifier identifying a second user. The method also can include presenting, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user. The method also can include determining to which of the plurality of the user selectable product content the second user responds. The method also can include, responsive to determining to which of the plurality of the user selectable product content the second user responds, determining, using a processor, a level of interest of the second user in at least one type of the product based, at least in part, on which of the plurality of the user selectable product content the second user responds. The method also can include, responsive to determining the level of interest of the second user in at least one type of the product, determining at least a first recommendation for a gift for the second user. The method also can include presenting to the first user the first recommendation for the gift for the second user.

A system includes a processor programmed to initiate executable operations. The executable operations include receiving, from a first user, a user identifier identifying a second user. The executable operations also can include presenting, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user. The executable operations also can include determining to which of the plurality of the user selectable product content the second user responds. The executable operations also can include, responsive to determining to which of the plurality of the user selectable product content the second user responds, determining a level of interest of the second user in at least one type of the product based, at least in part, on which of the plurality of the user selectable product content the second user responds. The executable operations also can include, responsive to determining the level of interest of the second user in at least one type of the product, determining at least a first recommendation for a gift for the second user. The executable operations also can include presenting to the first user the first recommendation for the gift for the second user.

A computer program includes a computer readable storage medium having program code stored thereon. The program code is executable by a processor to perform a method. The method includes receiving, by the processor, from a first user, a user identifier identifying a second user. The method also can include presenting, by the processor, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user. The method also can include determining, by the processor, to which of the plurality of the user selectable product content the second user responds. The method also can include, responsive to determining to which of the plurality of the user selectable product content the second user responds, determining, by the processor, a level of interest of the second user in at least one type of the product based, at least in part, on which of the plurality of the user selectable product content the second user responds. The method also can include, responsive to determining the level of interest of the second user in at least one type of the product, determining, by the processor, at least a first recommendation for a gift for the second user. The method also can include presenting, by the processor, to the first user the first recommendation for the gift for the second user.

### BRIEF DESCRIPTION OF THE DRAWINGS

FIG. 1 is a block diagram illustrating an example of a network computing environment.

FIG. 2 depicts an example of a user interface presented by a gift advisor service.

FIG. 3 is a block diagram illustrating example architecture for a data processing system.

FIG. 4 is a flow chart illustrating an example of a method of generating a recommendation for a gift for a user.

### DETAILED DESCRIPTION

This disclosure relates to data processing systems, and more specifically, to data processing systems that provide Web services. In accordance with the arrangements described herein, a gift advising service can be executed by a data processing system to determine gifts a user may appreciate receiving. For example, a first user can provide information for a second user for whom the first user needs gift ideas. The gift advising service can present to the second user product content that is user selectable and monitor the second user's responses to the product content. For example, the product content can be presented to the second user via one or more social networking services, one or more web based forums, via e-mail, via text messaging, and so on. Based, at least in part, on the second user's responses, the data processing system can determine gifts the second user may appreciate receiving. Notably, the gift advising service can monitor the responses of the second user in stealth mode, meaning that the second user need not have knowledge that that her interactions with product content 165 are being analyzed in order to determine recommendations of gifts for her. Thus, the second user can be pleasantly surprised when she receives a gift determined by the gift advising service to match her interests and personality traits.

Several definitions that apply throughout this document now will be presented.

As defined herein, the term “user selectable product content” means content, communicated by a web based resource to a client device, that is user selectable by a user in a user interface of the client device. Examples of user selectable product content include, but are not limited to, advertisements, hyperlinks to web pages, posts in social networking services and posts in web based forums.

As defined herein, the term “personality trait” means a distinguishing quality or characteristic of a person (e.g., a user). As the term “personality trait” is defined herein, an interest of a person is not a personality trait. In this regard, a person has personality traits and interests. The person's interests may be influenced by the person's personality traits, but the interests are distinct from the personality traits.

As defined herein, the term “web based resource” means a resource accessed, via the Internet, by users using client devices. Examples of a web based resource include, but are not limited to, a social networking service, a web based forum, an electronic mail (e-mail) system, a text messaging system, and so on.

As defined herein, the term “client device” means a processing system including at least one processor and memory that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “social networking service” means an online service platform on which social networks or social relations are built among people who, for example, share interests, activities, backgrounds or real-life connections, and via which people can share information with one another. People can hold conversations in a social networking service by posting messages. As the term “social networking service” is defined herein, a messaging service per se (e.g., an e-mail service, a text messaging service, or an instant messaging service) is not a social networking service, though a social networking service can include an e-mail messaging service, a text messaging service and/or an instant messaging service in addition to one or more social networking components.

As defined herein, the term “web based forum” means is an online discussion site where people can post messages that are viewable by other people. For example, people can hold conversations in a web based forum by posting messages. Some messages posted in a web based forum may be responses to other posted messages, or ask questions related to other posted messages. As the term “web based forum” is defined herein, a messaging service per se (e.g., an e-mail service, a text messaging service, or an instant messaging service) is not a web based forum, though a web based forum can include an e-mail messaging service, a text messaging service and/or an instant messaging service in addition to one or more web based forum components.

As defined herein, the term “post” means to enter a message in a thread of a social networking service or a web based forum. A new thread can be created in which to enter the message, or the message can be entered into an existing thread.

As defined herein, the term “electronic message” means an e-mail or a text message sent to at least one user.

As defined herein, the term “e-mail” means an electronic mail delivered via a communication network to at least one user. An e-mail may be sent by one user to one or more other users. In this regard, an e-mail typically identifies at least recipient using a user name (e.g., e-mail address) corresponding to the recipient, or a group name corresponding to a group of recipients, in at least field within the e-mail, for example within a “To” field, “Cc” field and/or “Bcc” field in a header of the e-mail. A recipient may view an e-mail via an e-mail client, which may execute on a client device or a server to which a client device is communicatively linked.

As defined herein, the term “text message” means an electronic message comprising text delivered via a communication network to at least one user identified as a recipient. A text message may be sent by one user to one or more other users. In this regard, a text message typically identifies at least one recipient using a user name, user identifier, telephone number or the like. A text message also may comprise audio, image and/or multimedia content. A text message can be delivered, for example, using the short message service (SMS), the text messaging service (TMS) and/or the multimedia messaging service (MMS). A text message also may be referred to as an “instant message.” As defined herein, a text message itself is not a result generated by an Internet search engine per se, although a text message may contain one or more uniform resource identifiers, such as hyperlinks, which can be generated by an Internet search engine and copied, for example by a user (e.g., sender), into the text message. In this regard, if a user uses a web browser to access an Internet search engine to perform an Internet search, and the user receives results from the Internet search engine in the web browser, such results are not a text message as the term text message is defined herein.

As defined herein, the term “natural language analysis” means a process that derives a computer understandable meaning of a human language.

As defined herein, the term “human language” is a language spoken or written by human beings that is not a computer programing language. A “human language” may be referred to as a “natural language.”

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “user” means a person (i.e., a human being).

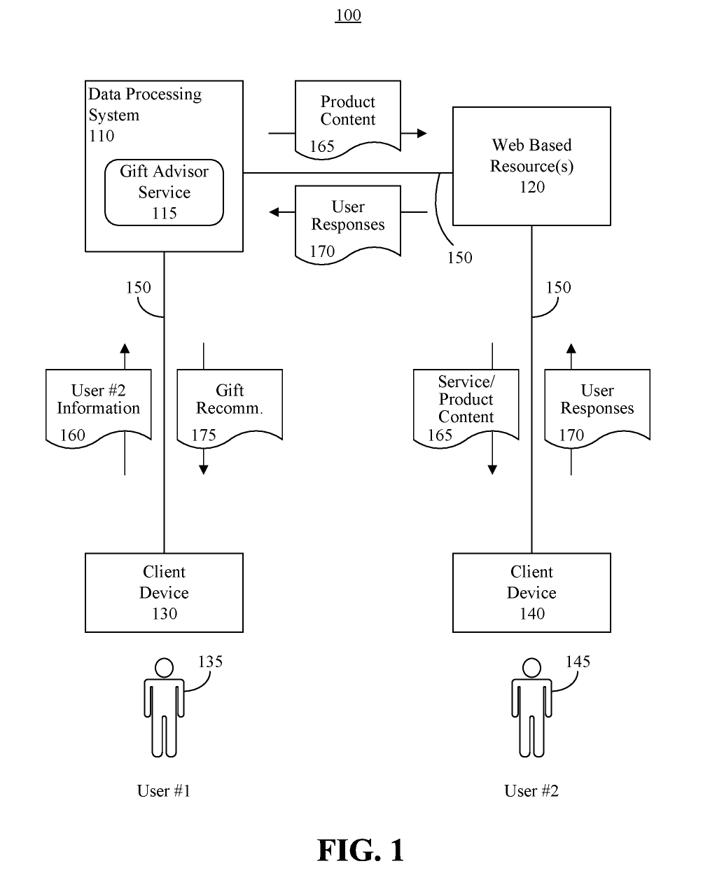

FIG. 1 is a block diagram illustrating an example of a network computing environment 100. The network computing environment 100 can include a data processing system 110, one or more web based resources 120, and a plurality of client devices 130 and 140. The data processing system 110, web based resources 120 and client devices 130 can be communicatively linked using at least one network 150. The network 150 is the medium used to provide communications links between various devices and data processing systems connected together within the network computing environment 100. The network 150 may include connections, such as wire, wireless communication links, or fiber optic cables. The network 150 can be implemented as, or include, any of a variety of different communication technologies such as a WAN, a LAN, a wireless network, a mobile network, a Virtual Private Network (VPN), the Internet, the Public Switched Telephone Network (PSTN), or similar technologies.

The data processing system 110 can include at least one hardware processor and memory. For example, the data processing system 110 can be implemented as a server, or implemented as a plurality of communicatively linked servers. The data processing system 110 can execute a gift advisor service 115, for example within an operating system hosted by the data processing system 110.

The web based resources 120 can include, for example, one or more social networking services, one or more web based forums, one or more e-mail systems, one or more text messaging services, and so on. The web based resources 120 can be hosted by one or more data processing systems (not shown) communicatively linked to the data processing system 110. For example, each web based resource 120 can be hosted by one or more servers.

In operation, a user 135 using the client device 130 can access the gift advisor service 115 hosted by the data processing system 110. The gift advisor service 115 can present, via a web browser or mobile application executed on the client device 130, a user interface. Interacting with the user interface, the user 135 can enter information 160 about the user 145.

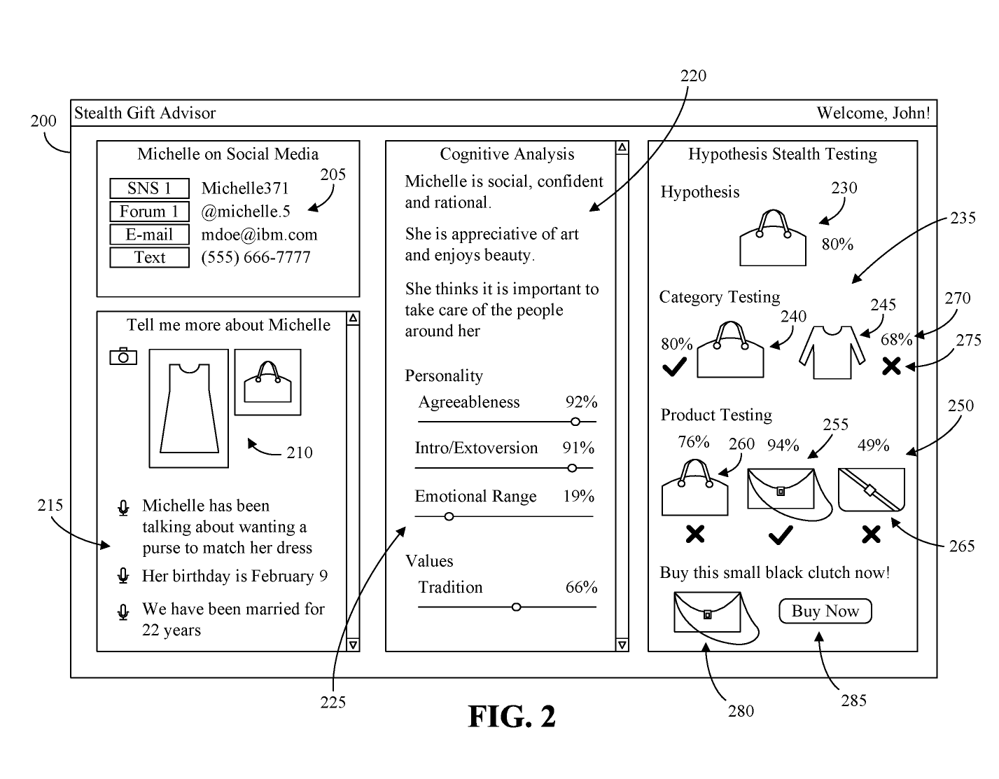

FIG. 2 depicts an example of a user interface 200 presented by the gift advisor service 115. Via the user interface 200, the gift advisor service 115 can prompt the user 135 to enter the information 160 of FIG. 1. The information 160 can include one or more social networking services and/or web based forums used by the user 145 and the user identifiers 205 for the user 145 in the corresponding social networking service(s)/web based forum(s). The information 160 also can include one or more e-mail addresses for the user 145, one or more text messaging addresses for the user 145, and so on.

The information 160 also can include one or more images 210 of things in which the user 145 has interest. For example, the user 135 can upload an image of a favorite dress of the user 145 that is in a color that is a favorite of the user 145. The user 135 also can upload an image of a favorite handbag of the user 145. The gift advisor service 115 can perform image recognition and image analysis on the images 210 to identify products depicted in the images 210 (e.g., identify a dress), and characteristics of such products (e.g., identify a type of the dress, a color of the dress, etc.). Image recognition and image analysis is known to those of ordinary skill in the art.

Further, the information 160 can include additional information 215 about the user 145, for example interests the user 145 has expressed, dates (e.g., birthdate and holidays) when the user 135 anticipates to give gifts to the user 145, and various other information. The information 160 also can include additional information (not shown in FIG. 2), for example a budget for a gift, organizations with which the user 145 is associated, products being considered for a gift, products to exclude from gift recommendations, and so on.

In one aspect of the present arrangements, the user 135 can provide the information 215 as natural language sentences. The user 135 can type or speak the information 215. In the case the user 135 speaks the information, the client device 130 can detect spoken utterances of the user 135 and perform speech recognition on the spoken utterances to generate text from the spoken utterances, or the client device 130 can communicate to the gift advisor service 115 detected audio and the gift advisor service can perform speech recognition on the spoken utterances to generate the text. Regardless of whether the client device or the gift advisor service 115 performs the speech recognition, the gift advisor service 115 can perform natural language processing on the text to derive a computer understandable meaning of the text, as is known to those of ordinary skill in the art.

The gift advisor service 115 can create a user profile for the user 145 and store the user information 160 in the user profile. Further, the gift advisor service 115 can analyze the information 160, and other information derived from the information 160, to determine traits of the user that may impact the gift preferences of the user 145. In one aspect, to derive the other information, the gift advisor service 115 can use the user identifiers 205 to access posts by the user 145 in the social networking service(s) and/or web based forum(s), access responses of the user 145 to posts by other users, and so on. Further, the gift advisor service 115 can perform image recognition and image analysis on the images shared by the user 145 in the social networking service(s) and/or web based forum(s) to identify products depicted in the images and characteristics of such products.

The gift advisor service 115 can perform cognitive analysis on the information 160, and other information derived from the information 160, to generate cognitive analysis results 220 indicating the traits of the user 145 that may impact the gift preferences of the user 145. In another arrangement, the gift advisor service 115 can communicate the information 160, and other information derived from the information 160, to a cognitive system (e.g., IBM® Watson), and receive from the cognitive system the cognitive analysis results 220. Cognitive analysis and cognitive systems are known to those of ordinary skill in the art. The gift advisor service 115 can store the cognitive analysis results 220 in the user profile of the user 145. Further, the gift advisor service 115 can present the cognitive analysis results 220 in the user interface 200.

In one arrangement, at least a portion 225 of the cognitive analysis results 220 can be user editable. For example, the gift advisor service 115 can present various personality traits identified in the cognitive analysis results 220 with slider bars, editable fields, etc. Further, the personality traits can be assigned a score based on the cognitive analysis. If the user 135 so chooses, the user can change the score assigned to one or more such personality traits. In illustration, the user 135 can move an indicator on a slider bar to adjust the score to a score the user 135 determines to be appropriate for the user 145. Responsive to the user changing any of the scores, the gift advisor service 115 can update the cognitive analysis results 220 with the changes and store the changes in the user profile of the user 145.

Based on the cognitive analysis results 220, the gift advisor service 115 can generate a hypothesis 230 of one or more types of products in which the user 145 has a threshold level of interest based on interests of the user 145 and user personality traits of the user 145, and thus may appreciate receiving as a gift. The interests and personality traits can be determined based on the information 215 entered by the user 135 and the cognitive analysis results 220. Referring again to FIG. 1, based on the hypothesis 230, the gift advisor service 115 can generate or access user selectable product content 165 corresponding to such types of products and, via the web based resource(s) 120, present the product content 165 to the user 145.

In illustration, the gift advisor service 115 can communicate the selectable product content 165 to the web based resource(s) 120 for presentation to the user 145. In illustration, if a web based resource 120 is a social networking service or a web based forum, the web based resource 120 can include the product content 165 in a post presented to the user 145 on a display of the client device 140, include the product content 165 as a user selectable advertisement (e.g., banner advertisement) displayed by the client device 140, and so on. If a web based resource 120 is an e-mail service, the web based resource 120 can include the product content 165 in an e-mail presented to the user 145 on a display of the client device 140. If a web based resource 120 is a text messaging service, the web based resource 120 can include the product content 165 in a text message presented to the user 145 on a display of the client device 140.

In another arrangement, the gift advisor service 115 can communicate a list of product categories and/or products to a marketing system (not shown). The marketing system can access or generate the selectable product content 165 based on the list, and coordinate with the web based resource(s) 120 to present the selectable product content 165 to the user 145.

Via the web based resource(s) 120, the client device 140 and, optionally, the marketing system, the gift advisor service 115 can monitor responses 170 of the user 145 to the product content 165. For example, the gift advisor service 115 can determine to which of the product content 165 the user 145 responds, and the nature of the responses. By way of example, using known techniques, via the client device 140, the web based resource(s) 120 can detect inputs of the user 145 selecting the product content 165, or pinning or posting the product content 165 to a social networking service, and communicate such detected responses 170 to the gift advisor service 115. In another example, via the client device 140, the web based resource(s) 120 can detect whether the user hovers a cursor over the product content 165 for a threshold amount of time using known techniques, and communicate corresponding data as detected user responses 170 to the gift advisor service 115.

The product content 165 can include a hyperlink that, responsive the user 145 selecting or hovering over the product content 165, navigates the user to a web page containing information about a product that is a subject of the product content 165. If the user 145 selects the product content 165, or hovers over the product content 165 for a threshold period of time, the client device 140 can navigate the user 145 to the web page. The system hosting the web page can be configured to communicate to the web page resource 120 an amount of time the user 145 spends on the web page by virtue of the user 145 navigating to the web page by selecting or hovering over the product content 165, and the web page resource 120 can indicate that amount of time to the gift advisor service 115. In another arrangement, the system hosting the web page can be configured to communicate the amount of time directly to the gift advisor service 115. In the case that the product content 165 is presented as a post in a social networking service or web based forum, the web based resource(s) 120 also can determine whether the user 145 posts a response to such post (e.g., a like, etc.), and communicate the response as a user response 170.

At this point it should be noted that the user 145 need not be made aware that the product content 165 is presented to the user 145 in order to determine a gift recommendation for consideration by the first user 135. Instead, the product content 165 can be depicted on the display of the client device 140 to appear as conventional content that otherwise may be presented to the user 145. In this regard, the processes described herein can be referred to as stealth mode gift advising since the user 145 does not have knowledge that her interactions with product content 165 are being analyzed in order to determine recommendations of gifts for her that she will appreciate receiving.

Further, the gift advisor service 115 can present to the user 145 product content 165 for a plurality of different product items that match the hypothesis 230 of one or more types of products that the user 145 has at least a threshold level of interest, and thus may appreciate receiving as a gift. For example, various product content 165 can present different categories (e.g., types) of products, different sizes of products, different colors of products, different materials from which products are made, etc. In illustration, the gift advisor service 115 can present to the user 145 a first product content 165 for a particular model of purse in a particular color and material, a second product content 165 for the same type of purse but made in a different color, a third product content 165 for the same type of purse but made of a different material, a fourth product content 165 for a different model of purse, a fifth product content 165 for a dress in a first color, a sixth product content 165 for the same type of dress but in a different size, a seventh product content 165 for the same type of dress but made of a different material, an eighth product content 165 for a different type of dress, and so on.

For each product content 165 presented to the user 145, the gift advisor service 115 can determine, based on the user responses 170, whether the user 145 selected the product content 165 and how much time the user 145 spent reviewing the corresponding product. The gift advisor service 115 can determine whether the user 145 ignored certain product content 165. Moreover, the gift advisor service 115 can analyze the user responses 170 to determine interests/preferences of the user 145 relating to categories of products, colors, materials, sizes, etc. that are of interest to the user 145. In addition, the gift advisor service 115 can access the web based resource(s) 120, as well as other data resources (e.g., manufacturer and/or retail databases), to determine categories of products, product colors, product sizes, etc. that are trending in popularity. The gift advisor service 115 can access the web based resource(s) 120, as well as other data resources, to identify feedback and/or testing results regarding various products.

The gift advisor service 115 can analyze the user responses to the product content 165, the information 160 received from the user, information derived from the information 160 received from the user, trending information relating to popularity of products and/or testing results for products to determine (e.g., using cognitive analysis) a level of interest of the user 145 in particular categories of products and a level of interest of the user 145 in specific products. Further, the gift advisor service 115 can analyze the user responses to further refine the cognitive analysis results 220 pertaining to personality traits of the user 145, and the determined level of interest of the user 145 can be based, at least in part, on the refined cognitive analysis results 220. In another arrangement, the gift advisor service 115 can utilize a cognitive system (e.g., IBM® Watson) to perform the analyses.

Further, the gift advisor service 115 can determine whether the levels of interest exceed respective threshold values. If the level of interest of the user 145 in a specific category exceeds a respective threshold value, the gift advisor service 115 can determine that the user 145 would appreciate receiving as a gift a product within the specific category. If the level of interest of the user 145 in a specific category does not exceed a respective threshold value, the gift advisor service 115 can determine that the user 145 would not appreciate receiving as a gift a product within the specific category. Similarly, if the level of interest of the user 145 in a specific product exceeds the threshold value, the gift advisor service 115 can determine that the user 145 would appreciate receiving that specific product as a gift. If the level of interest of the user 145 in a specific product does not exceed the threshold value, the gift advisor service 115 can determine that the user 145 would not appreciate receiving that specific product as a gift. The gift advisor service 115 can communicate corresponding gift recommendation(s) 175 to the client device 130 for presentation to the user 135, for example via the user interface 200.

In illustration, referring again to FIG. 2, the gift advisor service 115 can present in the user interface 200 results 235 of category testing. The results 235 can indicate at least one category 240 of products the gift advisor service 115 determines the user 145 would appreciate receiving a gift. Optionally, the results 235 also can indicate at least one category 245 of products the gift advisor service 115 determines the user 145 would not appreciate receiving a gift. In one non-limiting arrangement, the gift advisor service 115 can represent the product categories 240, 245 in the user interface 200 with icons or images of products in the respective categories.

Further, the results 250 can select one or more products 255, 260, 265 from the product category 240 that fit the results of the cognitive analysis (e.g., match the personality traits and interests of the second user 145), and indicate at least one product 255 the gift advisor service 115 determines the user 145 would appreciate receiving a gift. Optionally, the results 250 also can indicate at least one product 260, 265 the gift advisor service 115 determines the user 145 may appreciate receiving a gift, but for which there is a lower propensity of matching the personality traits and interests of the second user 145. When selecting the products 255, 260, 265, the gift advisor service 115 can exclude from the selection products, or product types, indicated by the first user 135 to exclude from the gift recommendation. In one non-limiting arrangement, the gift advisor service 115 can represent the products 255, 260, 265 in the user interface 200 with images of the products 255, 260, 265.

In illustration, for each category and product, the gift advisor service 115 can determine a respective score 270 assigned to the category/product based on the determined level of interest of the user 145 in the category/product. To generate the scores, the cognitive analysis can include propensity modeling, which is known in the art. The gift advisor service 115 can select the categories 240, 245 and products 255, 260, 265 based on the respective scores 270. In one arrangement, the gift advisor service 115 can present the respective scores 270 in the user interface 200. In addition, the gift advisor service can present in the user interface 200 an indicator 275 indicating whether the score at least meets a threshold value that is to be met in order to be recommended as a gift to the user 145. Each score 270 can indicate a probability the user 145 would appreciate receiving a product (or category of product) as a gift based on the aforementioned cognitive processing.

In one arrangement, the gift advisor service 115 service can limit the products 255, 260, 265 presented in the user interface 200 to those products that fit within a budget indicated by the user 135. For example, if the user 135 specifies a budget between $50 and $75, the gift advisor service 115 service can limit the products 255, 260, 265 to those products that cost between $50 and $75. In a further arrangement, the gift advisor service 115 also can present certain products that are assigned a score that exceeds a threshold value, even if the products exceed the maximum budget. Continuing with the previous example, if the threshold score is 90%, and the product 255 is assigned a score of 94%, but the product costs $85, the gift advisor service 115 can present the product 255 in the user interface. In one arrangement, when setting the budget, the user 135 can specify an amount the budget may be exceeded for products 255, 260, 265 that score very high, for example over a threshold score. Thus, products 255, 260, 265 for which the cost exceed the maximum budget can still be presented to the user 135 if their score 270 exceeds the threshold score. Optionally, the gift advisor service 115 can present an indicator (not shown) with the product 255 to indicate that the product 255 costs more than the maximum budget. For example, the gift advisor service 115 can present a dollar sign near an image of the product 255, or near a score 270 or indicator 275 assigned to the product 255.

Further, the gift advisor service 115 can present in the user interface 200 an option that allows the user 135 to purchase a gift, for example the product 255. In illustration, the gift advisor service 115 can present an image 280 of the product 255 and, near that image, a user selectable button 285 or icon which the user 135 may select to initiate purchase of the product 255. Responsive to the user 135 selecting the button 285 or icon, the gift advisor service 115 can navigate the web browser or web application being used to a webpage on which the product 255 is offered for sale. In another arrangement, responsive to the user 135 selecting the button 285 or icon, the gift advisor service 115 can present a message to the user 135 indicating at least one store within a threshold distance from the user's location that carries the product 255 for sale.

In some cases, the user 135 may desire to view other products or other product categories. For example, if none of the scores 270 determined for the products 255, 260, 265 are high enough for the user 135 to feel comfortable making purchase decision for the products 255, 260, 265, or the user 135 does not feel the products 255, 260, 265 are good gift choices, the user may choose to view other products or other product categories. Moreover, the user 135 may choose to update the information 215 about the user 145. For example, the user may add additional information 215, edit information 215 or delete information 215. In an arrangement in which at least a portion 225 of the cognitive analysis results 220 are user editable, the user 145 also can edit such results 220. In addition, the user 135 can provide feedback on the product recommendations. By way of example, if the user 135 does not think the user 145 will like a type of material from which the product 255 is made, the user 135 can add information 215 indicating that the user 145 probably would not like that type of material. Further, the user 135 can add information indicating a type of material the user 135 believes the user 145 would prefer. The user 145 can select an icon, button, menu item, or the like to initiate the gift advisor service 115 to perform a new cognitive analysis based on the updated information 215 and feedback, and generate new gift recommendations, for example as previously described. The new gift recommendations can be presented to the user 135 in the user interface 200.

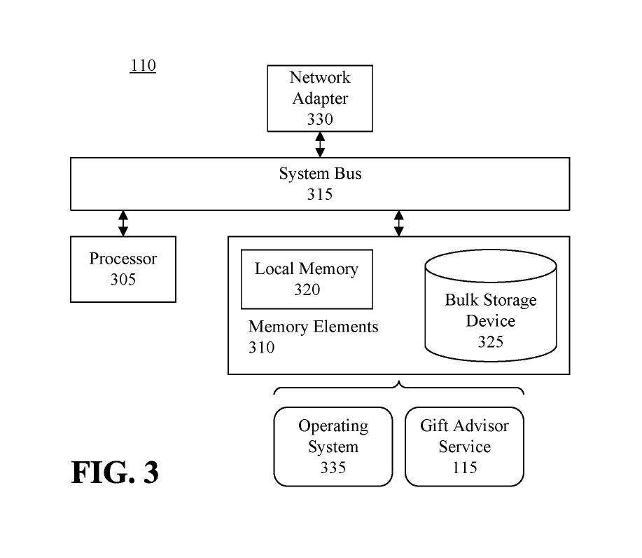

FIG. 3 is a block diagram illustrating example architecture for the data processing system 110. The data processing system 110 can include at least one processor 305 (e.g., a central processing unit) coupled to memory elements 310 through a system bus 315 or other suitable circuitry. As such, the data processing system 110 can store program code within the memory elements 310. The processor 305 can execute the program code accessed from the memory elements 310 via the system bus 315. It should be appreciated that the data processing system 110 can be implemented in the form of any system including a processor and memory that is capable of performing the functions and/or operations described within this specification. For example, the data processing system 110 can be implemented as a server, a plurality of communicatively linked servers, and so on.

The memory elements 310 can include one or more physical memory devices such as, for example, local memory 320 and one or more bulk storage devices 325. Local memory 320 refers to random access memory (RAM) or other non-persistent memory device(s) generally used during actual execution of the program code. The bulk storage device(s) 325 can be implemented as a hard disk drive (HDD), solid state drive (SSD), or other persistent data storage device. The data processing system 110 also can include one or more cache memories (not shown) that provide temporary storage of at least some program code in order to reduce the number of times program code must be retrieved from the bulk storage device 325 during execution.

At least one network adapter 330 can be coupled to the data processing system 110. The network adapter 330 can be coupled to the data processing system 110 either directly or through intervening I/O controllers. The network adapter 330 can enable the data processing system 110 to become coupled to other systems, computer systems, remote printers, and/or remote storage devices through intervening private or public networks. Modems, cable modems, transceivers, and Ethernet cards are examples of different types of network adapters 330 that can be used with the data processing system 110.

As pictured in FIG. 3, the memory elements 310 can store the components of the data processing system 110 of FIG. 1, namely an operating system 335 and the gift advisor service 115. Being implemented in the form of executable program code, these components of data processing system 110 can be executed by the processor 305 of the data processing system 110 and, as such, can be considered part of the data processing system 110. Moreover, the gift advisor service 115, user profiles generated/maintained by the gift advisor service 115 and product content 165 used by the gift advisor service 115 are functional data structures that impart functionality when employed as part of the data processing system 110.

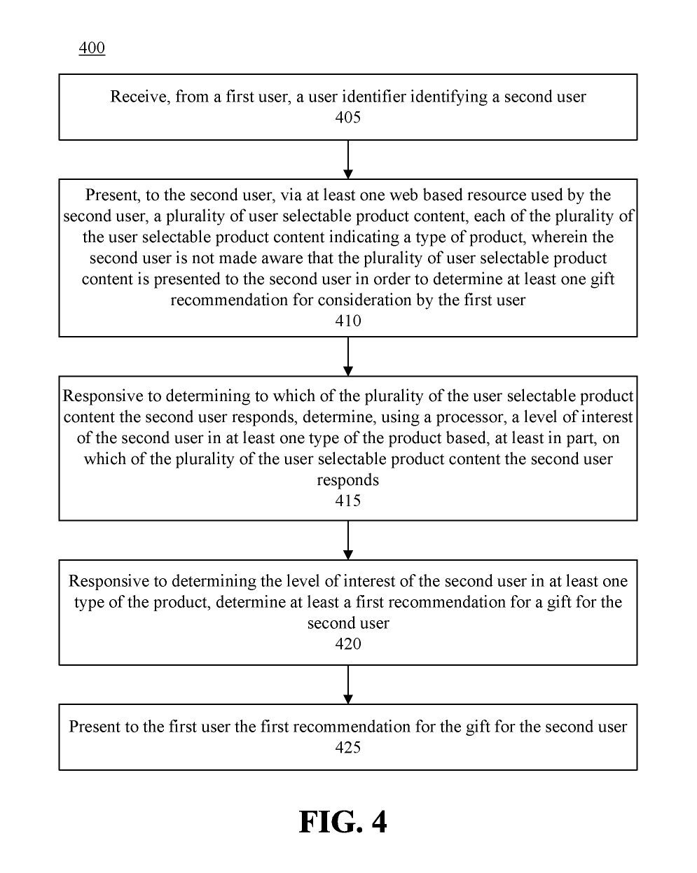

FIG. 4 is a flow chart illustrating an example of a method 400 of generating a recommendation for a gift for a user. The method 400 can be implemented by the data processing system 110 of FIGS. 1 and 3 and, more particularly, can be implemented by the gift advisor service 115.

At step 405, the gift advisor service can receive, from a first user, a user identifier identifying a second user. At step 410, the gift advisor service can present, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user. At step 415, the gift advisor service can, responsive to determining to which of the plurality of the user selectable product content the second user responds, determine, using a processor, a level of interest of the second user in at least one type of the product based, at least in part, on which of the plurality of the user selectable product content the second user responds. At step 420, the gift advisor service can, responsive to determining the level of interest of the second user in at least one type of the product, determine at least a first recommendation for a gift for the second user. At step 425, the gift advisor service can present to the first user the first recommendation for the gift for the second user.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, from a first user, a user identifier identifying a second user;
presenting, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user;
determining to which of the plurality of the user selectable product content the second user responds;
responsive to determining to which of the plurality of the user selectable product content the second user responds, determining, using a processor, a level of interest of the second user in at least one type of the product based, at least in part, on which of the plurality of the user selectable product content the second user responds;
responsive to determining the level of interest of the second user in at least one type of the product, determining at least a first recommendation for a gift for the second user; and
presenting to the first user the first recommendation for the gift for the second user.

2. The method of claim 1, wherein the level of interest of the second user in at least one type of the product further is determined based on information about the second user provided by the first user.

3. The method of claim 1, further comprising:
determining personality traits of the second user based, at least in part, on information about the second user provided by the first user;
wherein the level of interest of the second user in at least one type of the product further is determined based on the determined personality traits of the second user.

4. The method of claim 3, further comprising:
refining a determination of the personality traits of the second user based, at least in part, on which of the plurality of the user selectable product content the second user responds.

5. The method of claim 1, further comprising:
receiving, from the first user, feedback pertaining to the first recommendation of the gift for the second user; and
determining at least a second recommendation for the gift for the second user by analyzing the feedback and the determined level of interest of the second user in the at least one type of the product; and
presenting to the first user the second recommendation for the gift for the second user.

6. The method of claim 1, further comprising:
receiving from the first user an indication of a maximum budget for gifts;
generating a score for a product, the score indicating a probability the second user would appreciate receiving the product as the gift;
determining that the score for the product exceeds a threshold score and determining that a cost of the product exceeds the maximum budget for gifts; and
responsive to determining that the score for the product exceeds the threshold score and determining that the cost of the product exceeds the maximum budget for gifts, selecting the product for the first recommendation for the gift for the second user based on the score.

7. The method of claim 1, further comprising:
receiving from the first user an indication to exclude a particular type of product from the first recommendation;
wherein the user selectable product content, presented to the second user, indicating the type of product does not include the excluded particular type of product.

8. A system, comprising:
a processor programmed to initiate executable operations comprising:
receiving, from a first user, a user identifier identifying a second user;
presenting, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user;
determining to which of the plurality of the user selectable product content the second user responds;
responsive to determining to which of the plurality of the user selectable product content the second user responds, determining a level of interest of the second user in at least one type of the product based, at least in part, on which of the plurality of the user selectable product content the second user responds;
responsive to determining the level of interest of the second user in at least one type of the product, determining at least a first recommendation for a gift for the second user; and
presenting to the first user the first recommendation for the gift for the second user.

9. The system of claim 8, wherein the level of interest of the second user in at least one type of the product further is determined based on information about the second user provided by the first user.

10. The system of claim 8, the executable operations further comprising:
determining personality traits of the second user based, at least in part, on information about the second user provided by the first user;
wherein the level of interest of the second user in at least one type of the product further is determined based on the determined personality traits of the second user.

11. The system of claim 10, the executable operations further comprising:
refining a determination of the personality traits of the second user based, at least in part, on which of the plurality of the user selectable product content the second user responds.

12. The system of claim 8, the executable operations further comprising:
receiving, from the first user, feedback pertaining to the first recommendation of the gift for the second user; and
determining at least a second recommendation for the gift for the second user by analyzing the feedback and the determined level of interest of the second user in the at least one type of the product; and
presenting to the first user the second recommendation for the gift for the second user.

13. The system of claim 8, the executable operations further comprising:
receiving from the first user an indication of a maximum budget for gifts;
generating a score for a product, the score indicating a probability the second user would appreciate receiving the product as the gift;
determining that the score for the product exceeds a threshold score and determining that a cost of the product exceeds the maximum budget for gifts; and
responsive to determining that the score for the product exceeds the threshold score and determining that the cost of the product exceeds the maximum budget for gifts, selecting the product for the first recommendation for the gift for the second user based on the score.

14. The system of claim 8, the executable operations further comprising:
receiving from the first user an indication to exclude a particular type of product from the first recommendation;
wherein the user selectable product content, presented to the second user, indicating the type of product does not include the excluded particular type of product.

15. A computer program product comprising a computer readable storage medium having program code stored thereon, the program code executable by a processor to perform a method comprising:
receiving, by the processor, from a first user, a user identifier identifying a second user;
presenting, by the processor, to the second user, via at least one web based resource used by the second user, a plurality of user selectable product content, each of the plurality of the user selectable product content indicating a type of product, wherein the second user is not made aware that the plurality of user selectable product content is presented to the second user in order to determine at least one gift recommendation for consideration by the first user;
determining, by the processor, to which of the plurality of the user selectable product content the second user responds;
responsive to determining to which of the plurality of the user selectable product content the second user responds, determining, by the processor, a level of interest of the second user in at least one type of the product based, at least in part, on which of the plurality of the user selectable product content the second user responds;
responsive to determining the level of interest of the second user in at least one type of the product, determining, by the processor, at least a first recommendation for a gift for the second user; and
presenting, by the processor, to the first user the first recommendation for the gift for the second user.

16. The computer program product of claim 15, wherein the level of interest of the second user in at least one type of the product further is determined based on information about the second user provided by the first user.

17. The computer program product of claim 15, the method further comprising:
determining personality traits of the second user based, at least in part, on information about the second user provided by the first user;
wherein the level of interest of the second user in at least one type of the product further is determined based on the determined personality traits of the second user.

18. The computer program product of claim 17, the method further comprising:
refining a determination of the personality traits of the second user based, at least in part, on which of the plurality of the user selectable product content the second user responds.

19. The computer program product of claim 15, the method further comprising:
receiving, from the first user, feedback pertaining to the first recommendation of the gift for the second user; and
determining at least a second recommendation for the gift for the second user by analyzing the feedback and the determined level of interest of the second user in the at least one type of the product; and
presenting to the first user the second recommendation for the gift for the second user.

20. The computer program product of claim 15, the method further comprising:
receiving from the first user an indication of a maximum budget for gifts;
generating a score for a product, the score indicating a probability the second user would appreciate receiving the product as the gift;
determining that the score for the product exceeds a threshold score and determining that a cost of the product exceeds the maximum budget for gifts; and
responsive to determining that the score for the product exceeds the threshold score and determining that the cost of the product exceeds the maximum budget for gifts, selecting the product for the first recommendation for the gift for the second user based on the score.
